(19) United States
(12) Patent Application Publication
(10) Pub. No.: US 2005/0259283 A1
(43) Pub. Date: Nov. 24, 2005

(54) Image recording method and image recording program

(75) Inventors: Tsuyoshi Hattori, Tokyo (JP); Kenji Kuwae, Tokyo (JP); Takeshi Saito, Tokyo (JP); Shunichi Kase, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/128,522

(22) Filed: May 13, 2005

(30) Foreign Application Priority Data
May 20, 2004 (JP) 2004-150971
Sep. 7, 2004 (JP) 2004-260283

(51) Int. Cl. H04N 1/40; H04N 1/407; H04N 1/50; G03G 15/00; G06K 15/14

(52) U.S. Cl. 358/1.9; 358/3.23; 358/3.21; 358/521; 399/45; 399/61

(57) ABSTRACT

An image recording method includes: obtaining an image data; performing a predetermined process to the obtained image data; creating a print based on an output data obtained from the outputted image data through an LUT; and changing a density of a specific density area in the image on the print; wherein the creating the print includes changing a part of the LUT substantially according to a density change instruction corresponding to the changing the density.

### BACKGROUND OF THE INVENTION

1. Field of the Invention

The present invention relates to an image recording method and an image recording program for printing an image data. In particular, the present invention relates to an image recording method and an image recording program being capable of easily adjusting an image quality by adjusting an image density by changing an LUT in an image recording unit of an image recording apparatus.

2. Description of Related Art

The present invention relates to an image recording method and an image recording program for printing an image data. In particular, the present invention relates to an image recording method and an image recording program being capable of easily adjusting an image quality by adjusting an image density by changing an LUT in an image recording unit of the image recording apparatus.

A service to receive an exposed photographic film from a client for performing a development and the like in a minilab has been generally provided in a photo studio or the like. Further, these days, since a digitization has been progressing rapidly in a photography industry in conjunction with a rapid popularization of a DSC (Digital Still Camera) (hereafter, it is referred to as “digital camera”), a digital minilab is now being so popularized as to take over the conventional minilab.

The digital minilab, which is an image recording apparatus, prints an image on a silver halide color developing paper from not only the conventional photographic film, but also various inputting media such as a printing document, an image data of the digital camera, a data of various recording media or the like, at a speed as fast as the conventional minilab while an image quality is kept as high as the conventional minilab. Further, the digital minilab also writes an image in a recording media such as CD and the like, in addition to the printing.

A user brings a film, a printing document, a digital camera or various recording media that store an image data, to the photo studio. Then, the user receives the print or the CD at the studio or via a mail delivery, and the user views the print, views an image recorded in the CD on a monitor, prints the image from the CD to an inkjet printer through a home PC, or the like. Further, what is known these days is a method of ordering an print from a web page, and of transmitting various image data photographed by a digital camera or the like by a user.

The digital minilab will be described in more detail. In the digital minilab, a negative film, a reversal film or the like is scanned by a transmission scanner to be inputted in an image inputting unit as an image data; a printing document or the like is scanned by a reflection scanner to be inputted as an image data; a data generated in a digital camera is inputted through a communication such as a USB, a network or the like, or through various recording media; or other types of digital images are inputted through the communication such as a USB, a network or the like, or through various recording media. Then, various image quality adjustments such as a density change, a color correction, a sharpness emphasis, a noise suppression and the like are applied to the inputted image data in an image processing unit, and the image data having an appropriate image quality is printed by an image recording unit.

Further, the image data having an appropriate image quality is recorded in various recording media or transmitted through a communication as a general-purpose image data, and is to be viewed on a monitor or printed by another printer. Enhancing an image to have an appropriate image quality as mentioned above is also called “image enhancement”.

For example of “image enhancement”, a method in which, by displaying an image data on a monitor, while viewing the image, an operator corrects a color tone, a density and a sharpness with dedicated keys, or the like (for example, see JP-Tokukaihei-09-163163A) is known.

In the image recording unit, a print having a high image quality is obtained by exposing a digital image data to a silver halide color photosensitive material with an array light source, a laser, a CRT (Cathode Ray Tube) or the like, and by developing it.

Then, in order to obtain an appropriate print, a series of processes based on properties of the image recording unit (a gradation conversion process using a Look Up Table (hereafter, it is referred to as “LUT”) according to exposure properties of a recording paper, a sharpening process using a spatial filter when the image is soft, and the like), a correction according to a deterioration and a change of the recording paper, and the like are performed in the image recording unit.

Meanwhile, in a photo studio in which a digital minilab is not set up, a system having a PC (Personal Computer) in combination with a thermal transfer printer such as a sublimation printer is set up for providing the service in order to print a digital image recorded in a digital camera or various recording media such as an MO (Magneto Optical disk), a CD (Compact Disc) or the like. In this system, the PC realizes the roles of the image inputting unit and the image processing unit, and an appropriate image adjustment is performed according to necessity.

However, depending on a content (scene) of the image, a case in which an expression of a black area in an image cannot be reproduced well when a density of a high density portion in the image appears too low, which is hereafter referred to as a “black reproduction” problem, or a case in which a black area in the image, especially a letter part, looks blurred when a density of a high density portion appears too high, which is hereafter referred to as a “blur” problem, may occur.

These problems occur because appropriate densities differ depending on a relation between properties of the image recording unit and properties of the recording material, and also depending on a scene.

When an image is to be recorded on a silver halide color photosensitive material, since there are a large density change and a large density variation especially in a high density area, there is a high possibility of having the “black reproduction” problem and/or the “blur” problem.

Further, in a thermal transfer printer having a system in which a density is increased by adding a heat, because of the recording properties thereof, there are a large density variation and a large density change in a high density portion by an influence from surrounding parts or the like. Therefore, depending on a scene, there is a case of having the problem of “black reproduction” and/or “blur”.

However, in “image enhancement” by the image processing unit, when adjustments of such “black reproduction” and “blur” are performed, since an image data corresponding to the properties of the image recording unit and the recording material is generated, a generality of the image data is lost. Therefore, when the adjusted image data is recorded in various recording media such as a CD or the like and then is viewed on a screen, or when the adjusted image is printed, there is a case in which the “black reproduction” problem still occurs in the image or a case in which the image contains too much of “blur”.

Such an incident may also occur when the adjusted image is distributed through a network communication, or when the adjusted image is printed at an external image outputting apparatus or the like.

Further, when an LUT is to be changed into a different LUT for the adjustment, the image quality may be deteriorated in a density range in which a density is not necessary to be changed.

### SUMMARY OF THE INVENTION

An image recording method of the present invention comprises: obtaining an image data; performing a predetermined process to the obtained image data; creating a print based on an output data obtained from the outputted image data through an LUT; and changing a density of a specific density area in an image of the print; wherein the creating the print includes changing a part of the LUT substantially according to a density change instruction corresponding to the changing the density.

Further, an image recording method of the present invention comprises: obtaining an image data; performing a predetermined process to the obtained image data; and creating a print based on an output data obtained from the outputted image data through an LUT; wherein the creating the print includes judging whether it is necessary to change a density of a specific density area based on an image related information, and changing a part of the LUT substantially based on a result of the judging.

Further, an image recording program of the present invention makes a computer execute: obtaining an inputted image as an image data; performing a predetermined process to the obtained image data; creating a print based on an output data obtained from the outputted image data through an LUT; wherein the creating the print includes changing a part of the LUT substantially according to an operation to change a density of a specific density area in the image.

Further, an image recording program of the present invention makes a computer execute: obtaining an inputted image as an image data; performing a predetermined process to the obtained image data; and creating a print based on an output data obtained from the processed image data through an LUT, wherein the creating the print includes judging whether it is necessary to change a density of a specific density area based on an image related information, and changing a part of the LUT substantially based on a result of the judging.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a perspective view showing a rough structure of an image recording apparatus in the present invention,

FIG. 2 is a block diagram showing a functional structure of the image recording apparatus in the present invention,

FIG. 3 is a view showing a black emphasis mode selection screen,

FIG. 4 is a view showing a screen for selecting ON/OFF of black emphasis for each input media,

FIG. 5 is a view showing a screen for selecting ON/OFF of black emphasis for each image unit to be printed,

FIG. 6 is a block diagram showing a functional structure of an image recording unit,

FIGS. 7A, 7B and 7C are LUTs of R, G and B respectively, which are used for turning black emphasis ON,

FIGS. 8A to 8F are LUTs when a density adjustment is performed at a plurality of steps,

FIGS. 9A and 9B are LUTs in which an area of a low density side is changed,

FIG. 10 is a flowchart of when black emphasis is performed in the first embodiment,

FIG. 11 is a flowchart of when black emphasis is performed in the second embodiment,

FIG. 12 is a flowchart of when black emphasis is performed in the third embodiment,

FIG. 13 is a screen for selecting a product type and a finishing surface type,

FIG. 14 is a flowchart of when black emphasis is performed in the fourth embodiment,

FIG. 15 is a screen for selecting a setting of a development process,

FIG. 16 is a flowchart of when black emphasis is performed in the fifth embodiment,

FIG. 17 is a flowchart of when black emphasis is performed in the sixth embodiment,

FIG. 18 is a flowchart of when black emphasis is performed in the seventh embodiment,

FIG. 19 is a screen in which a plurality of channels are provided for setting a detail of black emphasis according to an image data,

FIG. 20 is a screen for setting a detail of black emphasis according to a scene,

FIG. 21 is a screen in which a plurality of channels are provided for setting a detail of black emphasis according to an image data, and

FIG. 22 is a flowchart of when black emphasis is performed in the ninth embodiment,

### PREFERRED EMBODIMENTS OF THE INVENTION

Hereinafter, embodiments of an image recording method and an image recording program will be described. First, a first embodiment of the present invention will be described with reference to drawings. However, the scope of the invention is not limited to the represented descriptions.

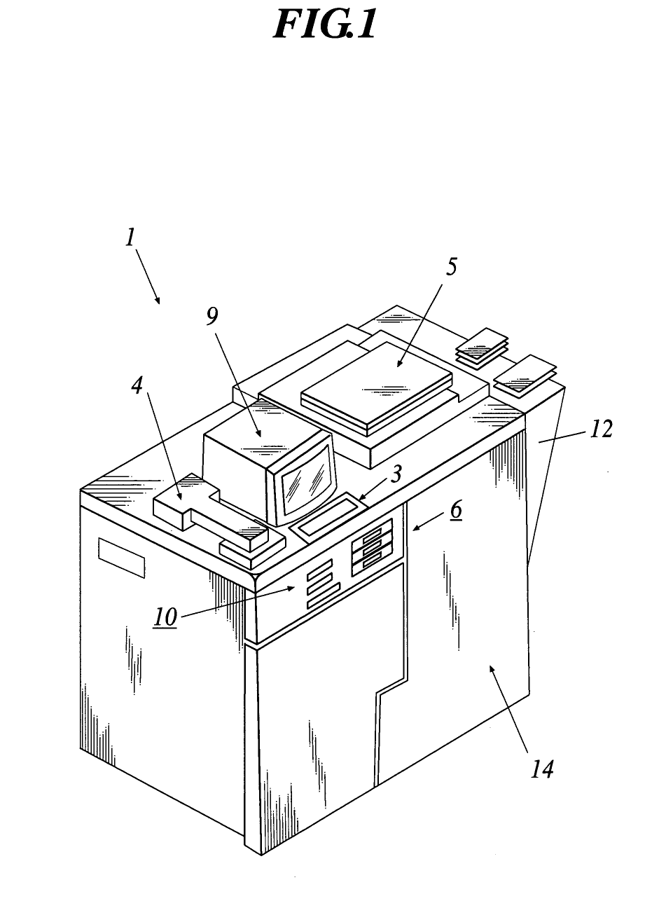

FIG. 1 shows a rough structure of an image recording apparatus in the present embodiment. The image recording apparatus 1 comprises an operating unit 3, a film scanner unit 4, a reflection document inputting unit 5, an image reading unit 6, a display unit 9, an image writing unit 10, a tray 12 and an image recording unit 14.

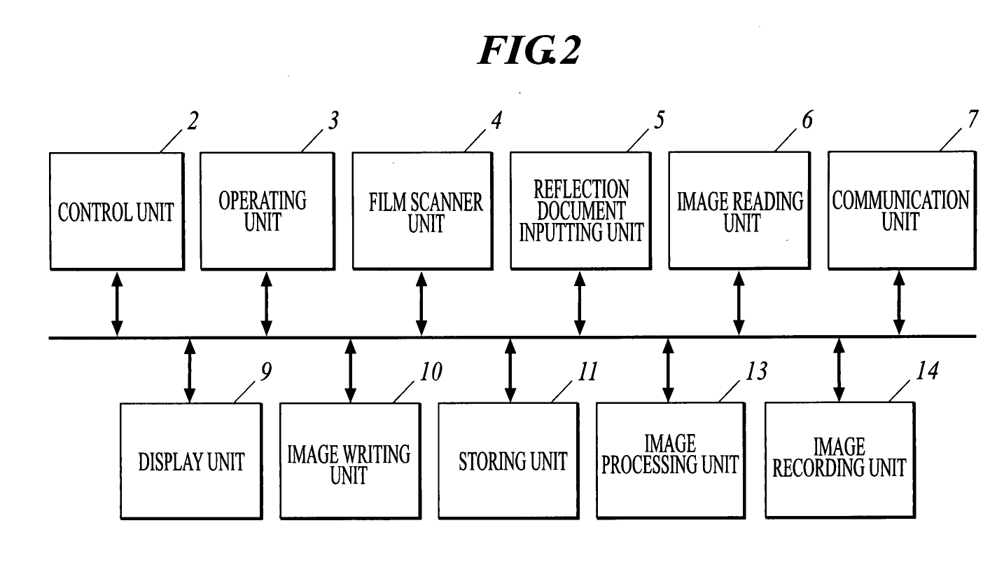

Next, FIG. 2 shows a functional structure of the image recording apparatus 1. As shown in FIG. 2, the image recording apparatus 1 comprises a control unit 2, the operating unit 3, the film scanner unit 4, the reflection document inputting unit 5, the image reading unit 6, a communication unit 7, the display unit 9, the image writing unit 10, a storing unit 11, an image processing unit 13 and the image recording unit 14.

The control unit 2 is a computer comprising a CPU (Central Processing Unit), a RAM (Random Access Memory), a ROM (Read Only Memory) and the like.

In response to a signal inputted from the operating unit 3 or the communication unit 7, the CPU reads out various control programs, for example an image processing program, stored in the ROM or the storing unit 11, and develops the read program into the RAM. Then, the CPU executes various processes in conjunction with the developed various programs, and controls each part of the image recording apparatus 1 to function.

The ROM is a semiconductor memory which is only used for reading-out, and stores program data to be executed by the CPU, or the like.

The RAM is a storage medium in which a data is temporarily stored. What are formed in the RAM are: a program area for developing programs to be executed by the CPU; a data area for storing a data inputted from the operating unit 3 or the communication unit 7, and for storing various processing results by the CPU or the like; an image data area for storing an image data inputted from the film scanner unit 4, the reflection document inputting unit 5, the image reading unit 6 and the communication unit 7; and the like. Here, the image data is a representation of a brightness and the like of respective color components in each pixel that is one of large number of small areas that are divided into from the image, as a signal intensity.

The operating unit 3 comprises numeric keys and various function keys. For example, the operating unit 3 comprises a touch panel or the like. By operating these keys, the operating unit 3 outputs an operation signal to the control unit 2.

The film scanner unit 4 is a device for reading a transparent document. According to a control of the control unit 2, the film scanner unit 4 as an image inputting unit reads an image data from the transparent document such as a color negative film or a color reversal film which was exposed by an analog camera and developed.

Further, the film scanner unit 4 may have a function to read an information recorded in a magnet layer of APS (Advanced Photo System) film.

The reflection document inputting unit 5 is the so-called flat bed scanner, and is a device for reading an image from a reflection document such as a print or the like. According to a control of the control unit 2, the reflection document inputting unit 5 as an image inputting unit reads an image data, an image accompanying data and the like recorded in various media.

The image reading unit 6 comprises an adapter for a PC card, an adapter for a floppy (trademark) disk, and an adapter for an optical disk, and it is possible to insert a PC card, a floppy disk and an optical disk to the image reading unit 6. The medium is not limited to them, and as long as the image reading unit 6 comprises a corresponding adapter, the medium may be an MO (Magneto Optical disk) and a ZIP (trademark). Further, the image reading unit 6 may comprise a device connecting port such as a network port, a USB or the like. What are stored in various media are, for example, a plurality of pieces of image data generated by a digital camera, image accompanying data, and order information (for example, DPOF (Digital Print Order Format) or the like). Further, an image data to which various processes such as an image synthesis, an editing or the like are applied is also stored. According to a control of the control unit 2, the image reading unit 6 as an image inputting unit reads the image data, the image accompanying data and the like recorded in various media.

Further, if a camera having a function to store an additional information such as an Exif information, for example a digital camera having an Exif correspondence, is used, the image reading unit 6 may have a function to read such an information from a medium that records an image generated by the camera.

The communication unit 7 as an image inputting unit receives an image data, an image accompanying data, a printing order and the like from a computer within a facility or a computer located far away through Internet or the like. In other words, the image recording apparatus 1 is capable of functioning as a network printer for printing a data received through a communication such as a network.

Further, the communication unit 7 transmits the image data, the image accompanying data, the order information and the like to another computer within the facility, to another network printer within the facility, or the computer located far away through Internet or the like.

The display unit 9 for example displays the image data that was read from the film scanner unit 4, the reflection document inputting unit 5 or the image reading unit 6 according to the control of the control unit 2, the image data received from the communication unit 7, an operation screen, and the like.

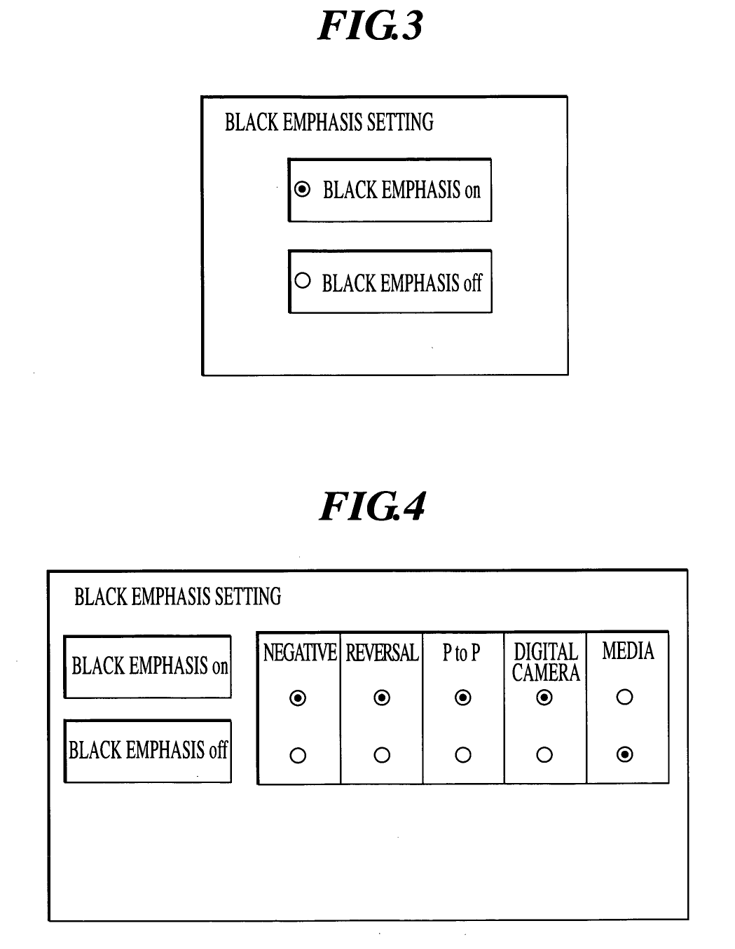

On the display unit 9, for example, a selection screen of a black emphasis mode as shown in FIG. 3 is displayed. On this screen, an information indicating a setting of black emphasis, and black emphasis ON/OFF is displayed. By operating the operating unit 3, either black emphasis ON or black emphasis OFF is selected.

Further, for example, a screen for selecting either black emphasis ON or black emphasis OFF for each input medium is displayed as shown in FIG. 4. This screen is displayed so that it is possible to select either black emphasis ON or black emphasis OFF for each input medium such as NEGATIVE, REVERSAL, PtoP, DIGITAL CAMERA, MEDIA and the like. By operating the operating unit 3, either black emphasis ON or black emphasis OFF is selected.

Here, in the above, “NEGATIVE” means an input mode of a negative film, “REVERSAL” means an input mode of a reversal film, “PtoP” means an input mode of a reflection document, “DIGITAL CAMERA” means an input mode of an image generated by a digital camera, and “MEDIA” means an input mode of an image of a recording medium such as a memory card, a CDR, a DVD, an FD and the like

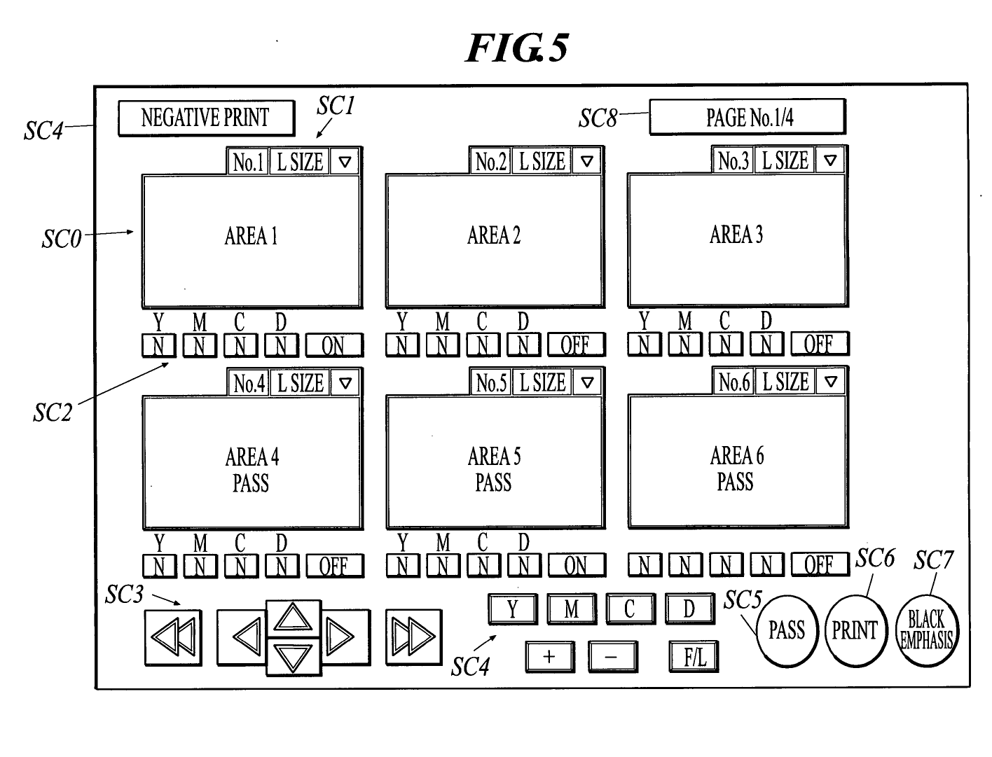

Further, for example, a screen for selecting either black emphasis ON or black emphasis OFF for each image unit to be printed is displayed as shown in FIG. 5. On this screen, six areas for displaying image areas of inputted image data are provided. However, the number of provided areas can be any. When total number of image data is more than the number of areas provided on one screen, the image data are divided to be displayed by using a plurality of screens. The screen further comprises: a size/page assigning button SC1 for assigning a size of an image data and a page number to be printed; a black emphasis assignment confirming portion SC2 for displaying whether black emphasis is to be assigned; a cursor button SC3 for selecting an image of which an image quality is to be adjusted; and an image quality adjusting button SC4 for minutely adjusting an image data. Further, the screen comprises: a PASS button SC5 for selecting an unnecessary image; a print button SC6 for starting a print; and a black emphasis button SC7 for an operation to select either black emphasis ON or black emphasis OFF. Then, when the number of displayed images is more than the number which one screen is capable of displaying, the images are displayed by using a plurality of screens, and for such a case, the screen comprises a display portion SC8 for displaying the total page number.

These displays are used for a case of managing a plurality of pieces of image data at once, such as a case of scanning a negative film, a case of managing images generated by a digital camera, and the like.

The image writing unit 10 comprises an adapter for a floppy disk, an adapter for an MO, and an adapter for an optical disk, and it is possible to insert a floppy disk, an MO and an optical disk to the image writing unit 10. The medium is not limited to them, and as long as the image writing unit 10 comprises a corresponding adapter, the medium can be a PC card, a Zip and the like. According to a control of the control unit 2, the image writing unit 10 writes the image data, the image accompanying data and the like in an image recording medium. Here, the reading by the image reading unit 6 and the writing by the image writing unit 10 may be performed by one adapter.

The storing unit 11 comprises, for example, an HDD (Hard Disk Drive), and stores programs, data and the like in the HDD according to a control of the control unit 2. Further, when the control unit 2 gives an instruction to read out a program, a data and the like, the storing unit 11 reads out the instructed information from the HDD and outputs the information to the control unit 2.

The image processing unit 13 performs an applicable image process to an image data inputted from the film scanner unit 4, the reflection document inputting unit 5 or the image reading unit 6, or an image data received by the communication unit 7, according to necessity. For example, the image processing unit 13 performs an image quality adjustment such as a calibration process which is appropriate to each inputting method, a gray balance adjustment, a contrast adjustment, a negative-positive conversion process in the case of a negative document, and the like. Further, according to necessity, the image processing unit 13 performs processes of: trimming; converting a size; synthesizing an image data; inputting a letter on an image data; and the like.

The image data to which “image enhancement” was done by applying these predetermined processes is stored in the storing unit 11, and as a general-purpose image data, a print thereof is generated by the image recording unit 14, and is recorded by the image writing unit 10 in various recording media such as a CD, an MO or the like, or is transmitted to another network printer through the communication unit 7, according to necessity.

Further, when an image is to be printed by the image recording unit 14, for the purpose of speeding up, there is a case in which the image data to which “image enhancement” was done is directly transmitted to the image recording unit 14 without going through the storing unit 11.

A type of the image data can be any, such as an RGB color image data, a monochrome image data, a CMYK 4-color image data and the like. Further, a gradation dimension is also any. For example, in the case of an RGB color image data, any image data such as 8 bits for each color, 12 bits for each color and the like can be used. As a format of the image, JPEG, Tiff, bmp or the like can be used, and a type thereof is not specifically limited. In the case of using a format having an image data and an image accompanying data such as JPEG, Tiff or the like, a process corresponding to each format which is to separate the image data and the image accompanying data, and to take out a necessary information from the image accompanying data is performed.

The image processing unit 13 realizes a software process in conjunction with the image processing program stored in the ROM and the control unit 2.

Further, when the image data is recorded in various recording media such as a CD, an MO or the like in the image writing unit 10, or when the image data is transmitted to another network printer or the like through the communication unit 7, the image processing unit 13 performs a conversion corresponding to a format of various image data. Here, a format of the image data to be processed is not particularly limited, and a process such as a corresponding format conversion or the like is performed. The image data can be an RGB color image data, a monochrome image data, a CMYK 4-color image data or the like, and a type thereof can be any. Further, a gradation dimension can be also any, for example, in the case of RGB color image data, any image data such as 8 bits for each color, 12 bits for each color or the like can be used. A type of an image format can be any (JPEG, Tiff, bmp or the like). In the case of using a format having an image data and an image accompanying data such as JPEG, Tiff or the like, the image data and the image accompanying data are used so as to correspond each other, and a process corresponding to each format is performed.

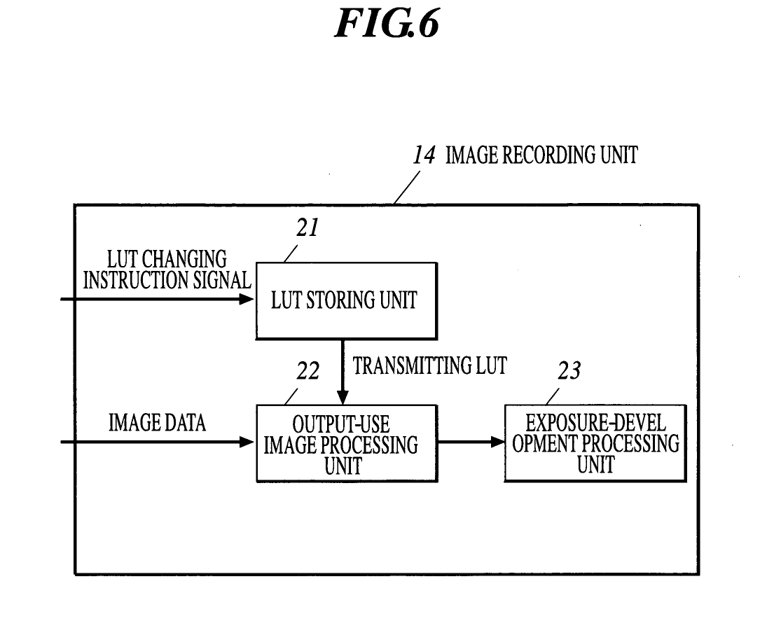

The image recording unit 14 comprises, as shown in FIG. 6, an LUT storing unit 21, an output-use image processing unit 22 and an exposure-development processing unit 23.

The LUT storing unit 21 comprises, for example, an HDD, and stores therein an LUT for changing an image data transmitted from the image processing unit 13. Further, when the control unit 2 changes the LUT, the LUT storing unit 21 reads out the assigned LUT from the HDD and transmits the LUT to the output-use image processing unit 22.

A horizontal axis of the LUT stored in the LUT storing unit 21 indicates an input signal, and it means 12-bit image data. A vertical axis of the LUT indicates an output signal, and it means a signal value to be given to a device that performs an image recording. In the case of using a silver halide color printing paper, the vertical axis means a signal value to be given to each of exposure devices of B, G and R.

Each of the input signal value and the output signal value of the LUT used in the present embodiment comprises 12 bits. However, a signal value used in the LUT of the present invention is not limited to such a case. A value in the LUT can be any, such as an 8-bit signal value, 16-bit signal value or the like.

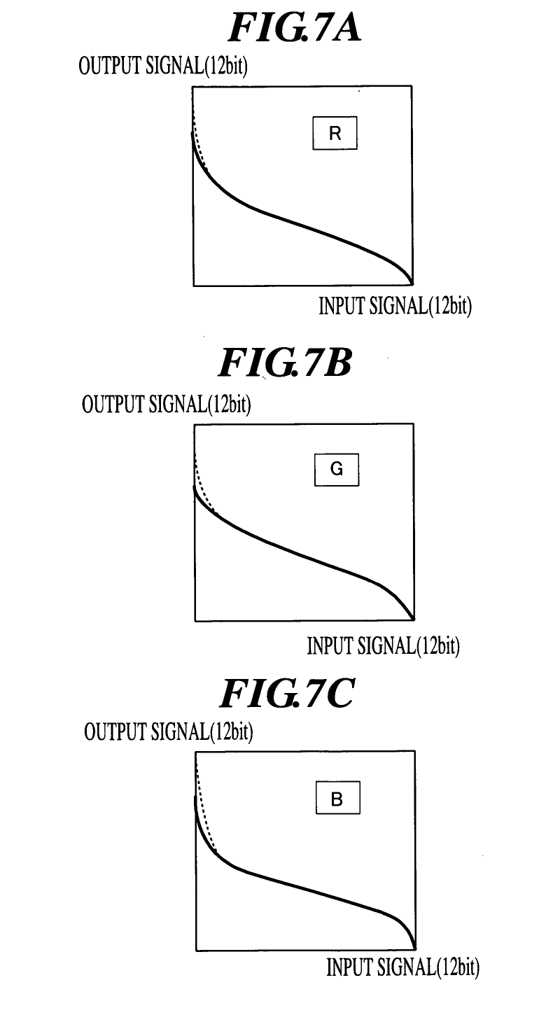

As an LUT stored in the LUT storing unit 21 and as an LUT before the change, for example, ones shown in FIGS. 7A to 7C can be used. FIG. 7A shows an LUT of R, FIG. 7B shows an LUT of G, and FIG. 7C shows an LUT of B, in each of which a continuous line corresponds to an LUT of black emphasis OFF, and a continuous line from a point contacted with the horizontal axis to a point contacted with a dotted line and the dotted line from a point contacted with the continuous line to a point contacted with the vertical axis corresponds to an LUT of black emphasis ON. This can also be applied to the LUTs hereafter.

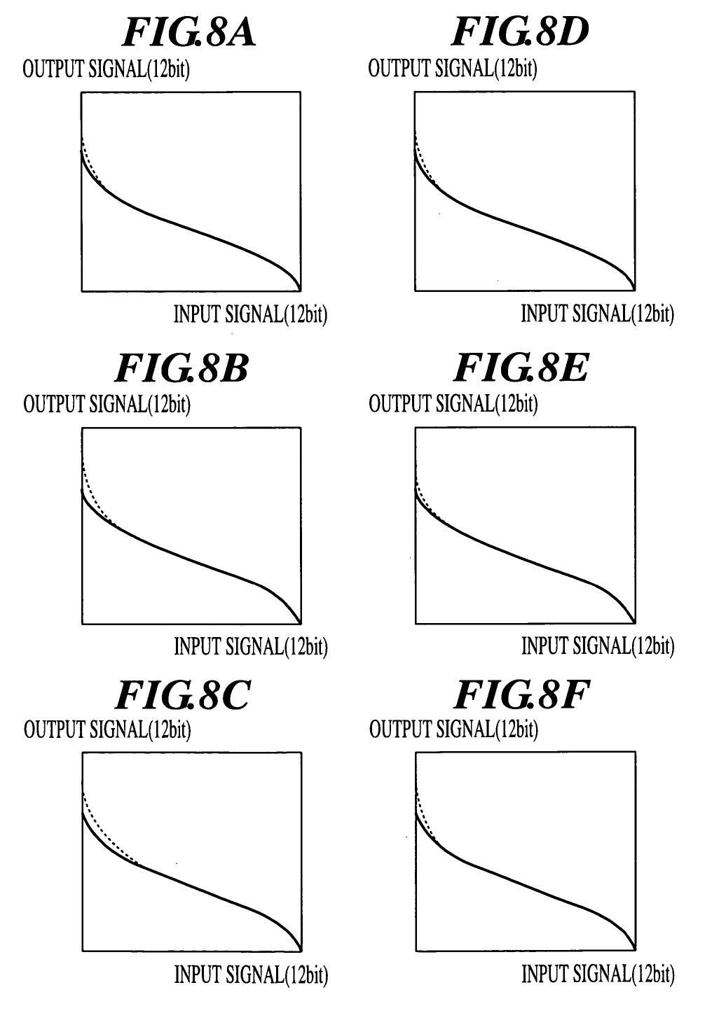

Further, for example, LUTs shown in FIGS. 8A to 8F, in which only values of a high density portion are different, can be used. All of FIGS. 8A to 8F show LUTs of G, in which a dotted line of FIG. 8A is an LUT in which a maximum density is 2.3 and a density range of not less than 1.9 is changed, a dotted line of FIG. 8B is an LUT in which a maximum density is 2.3 and a density range of not less than 1.7 is changed, a dotted line of FIG. 8C is an LUT in which a maximum density is 2.3 and a density range of not less than 1.55 is changed, a dotted line of FIG. 8D is an LUT in which a maximum density is 2.3 and a density range not of less than 2.05 is changed, a dotted line of FIG. 8E is an LUT in which a maximum density is 2.1 and a density range of not less than 1.9 is changed, and a dotted line of FIG. 8F is an LUT in which a maximum density is 2.45 and a density range of not less than 1.9 is changed.

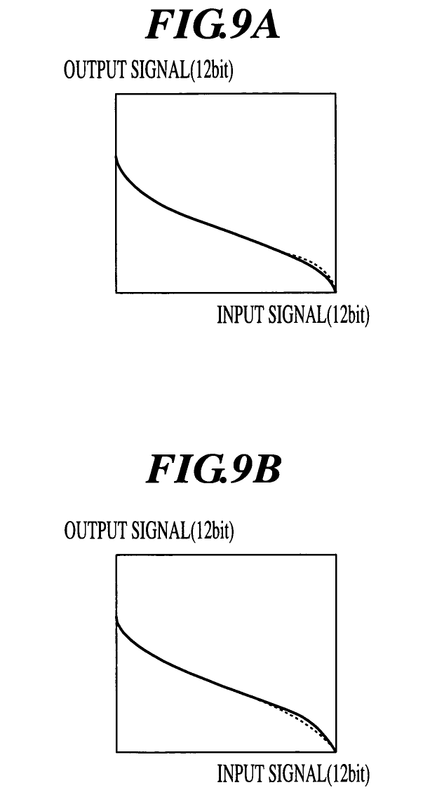

Further, for example, LUTs shown in FIGS. 9A and 9B can be used. The dotted-line LUT shown in FIG. 9A is an LUT that increases a density in a density area of a low density side, and the dotted-line LUT shown in FIG. 9B is an LUT that reduces a density in a density area of a low density side.

In FIGS. 7A to 7C and FIGS. 8A to 8F, as mentioned above, the continuous line from a point contacted with the horizontal axis to a point contacted with a dotted line and the dotted line from a point contacted with the continuous line to a point contacted with the vertical axis corresponds to an LUT of black emphasis ON, and the continuous line corresponds to an LUT of black emphasis OFF. In other words, since the continuous line from the point contacted with the horizontal axis to the point contacted with the dotted line is common between both the cases of black emphasis OFF and ON, the LUT before the change and the LUT after the change both being used in the present invention have a majority part in common and substantially only a portion is changed.

When the exposure device is set to be more bright in response to a larger input value, by using a silver halide color printing paper on which an output density increases in response to larger exposure amount corresponding to a larger signal value, an LUT has a decreasing shape as shown in FIGS. 8A to 9B. The LUT used in the present embodiment may be an LUT having an increasing shape according to properties of an image data, an exposure device, a printing paper and the like.

Here, ““only a portion” of an LUT is “substantially” changed” means, changing an LUT so that values of a range in which a density is necessary to be changed are changed, and values of a range in which a density is not necessary to be changed are either entirely equal to the values before the change or different but approximately the same as the LUT before the change. This can also be applied to descriptions hereafter.

Further, the high density portion means a density area having a density not less than a density value Dn as following.

The density value Dn has a higher density than a density value Dx defined as follows.
Dx=(Dmax−Dmin)×2/3+Dmin
where Dmax and Dmin are respectively a maximum density and a minimum density that are recordable by the image recording apparatus.

The maximum density recordable by the image recording apparatus is a state in which all the recording colors used for recording (for example, three colors of YMC in a case of using a sliver halide color printing paper) are respectively recorded at a recordable maximum density by the image recording apparatus.

The minimum density recordable by the image recording apparatus is a state in which all the recording colors used for recording are respectively at a recordable minimum density by the image recording apparatus, and when a silver halide color printing paper is used, a development process is performed without exposure.

Since a density range to be changed becomes narrower in response to making a high density portion narrower, while problems of “black reproduction” and “blur” of letters are solved, there is little influence on a density area of which a density is not necessary to change. Therefore, for example, by using an image recording apparatus in which the recordable high density is not less than 2.0, in all of an R density, a G density and a B density each being a color separation density of a gray print when the gray print is performed, preferably a density is changed so as to set a range of not less than 1.8 as the high density portion. Further, since a brightness is most closely related to the G density according to a human visual property, it is more preferable that a range of not less than 1.9 in the G density is set as the high density portion.

When an RGB image data is used, at least one among the LUTs of three colors: R, G and B may be changed. In consideration of a visual property in brightness, preferably the LUT of G is changed. Further, in view of black color balance, two colors are preferably changed, and in consideration of a visual property in brightness, G and R are preferably changed. In view of a black color balance, it is the most preferable to change all the LUTs of three colors.

Further, in the above, a one-dimension LUT is used for each color. However, a three-dimensional LUT having a table value for each combination of values of R, G and B for color conversion may be used.

Further, in the case of exposing a CMYK image data, one of the LUTS of C, M, Y and K may be changed, or a plurality of LUTs among the LUTs may be changed. When one of the LUTs of C, M, Y and K is changed, any one of the LUTs of C, M, Y and K may be changed. However, in consideration of a visual property of black, the LUT of K is preferably changed. Further, when a plurality of LUTs are changed, the number of LUTs to be changed may be any and the LUTs to be selected may be any among C, M, Y and K. However, in consideration of a visual property of black, all the LUTs of C, M, Y and K are preferably changed. In a case of changing three colors of LUTs, in consideration of a visual property in black, the LUTs of C, M and Y are preferably changed.

The output-use image processing unit 22 comprises, for example, a CPU. The output-use image processing unit 22 corrects the image data transmitted from the image processing unit 13 by using the LUT and a spatial filter according to properties of the image recording unit 14 and the recording material, and performs a calibration according to a variance of light amount.

The exposure-development processing unit 23 exposes a silver halide photosensitive material such as a silver halide color printing paper or the like taken out from a magazine (not shown) to a light based on the image data. Then, the exposed silver halide color photosensitive material is conveyed to the development processing unit, and an applicable development process is applied to the material be printed.

The image recording unit 14 may be any as long as it is a unit forming an image from the read image data. For example, the image recording unit 14 may be an image recording device using one of: an inkjet system; an electrophotograph system; a thermal recording system; and a sublimation system. The print generated by the image recording unit 14 is outputted to the tray 12.

Here, the image recording apparatus 1 shown in FIG. 1 has an apparatus structure in which the operating unit 3, the film scanner unit 4, the reflection document inputting unit 5, the image reading unit 6, the display unit 9, the image writing unit 10 and the image recording unit 14 are unified. However, at least one of the components may be provided separately from the others. Further, another film scanner, another reflection document inputting apparatus or the like may be connected to the image recording apparatus 1. In this case, the image processing unit 13 performs a process peculiar to each apparatus.

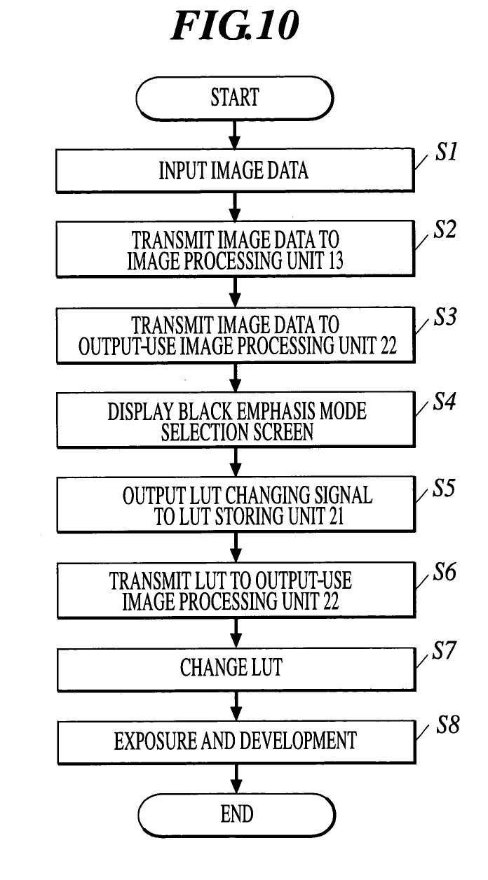

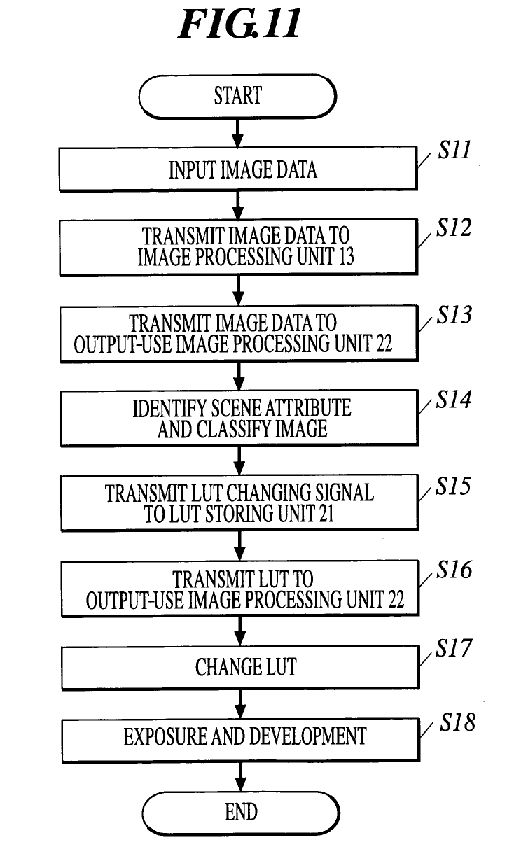

Next, an operation of the first embodiment will be described with reference to FIGS. 4 to 10.

Here, in the descriptions of the operation, it is assumed that the image data generated by the image processing unit 13 has the problem of “black reproduction”, and a change of an LUT is applied to a portion substantially and the change is applied to a high density portion.

First, when an image data is inputted from one of the film scanner unit 4, the reflection document inputting unit 5, the image reading unit 6 and the communication unit 7 (S1), the image data is transmitted to the image processing unit 13 (S2). When the image data is transmitted to the image processing unit 13, the control unit 2 reads out a program from the storing unit 11, and according to necessity, the image data that is after the image processing such as “image enhancement” according to various image adjustments, trimming, size conversion and the like, is displayed on the display unit 9, and also the image data is transmitted to the output-use image processing unit 22 (S3).

Next, an operator operates the operating unit 3 for inputting an operation signal to display a black emphasis mode selection screen, for example shown in FIG. 3, on the display unit 9 (S4), and further, when the operator operates the operating unit 3 for selecting a portion of “BLACK EMPHASIS ON” on the screen, an operation signal for turning a black emphasis mode ON is outputted to the control unit 2, and the control unit 2 transmits an LUT changing signal to the LUT storing unit 21 of the image recording unit 14 (S5).

The LUT storing unit 21 having received the LUT changing signal transmits the dotted-line LUTs shown in FIGS. 7A to 7C, which emphasize black, to the output-use image processing unit 22 (S6), and the continuous-line LUTs shown in FIGS. 7A to 7C, which have already been set as black emphasis OFF in an LUT storing area of the output-use image processing unit 22 is changed to the dotted-line LUT of black emphasis ON (S7).

Then, when the operator operates the operating unit 3 for an operation of printing the image data, the output-use image processing unit 22 and the exposure-development processing unit 23 perform predetermined processes, and a print recorded on the silver halide color photosensitive material is outputted to the tray 12 (S8).

In this way, it is possible to obtain a print on which black is suitably emphasized and thereby “black reproduction” is well adjusted.

Here, in the above-mentioned example, S4 is performed after S3. However, the operation of S1 may be started after black emphasis is turned ON by preliminarily performing S4. In this case, when the operator operates the operating unit 3 for an operation of printing the image data, S3 to S8 are sequentially performed.

Further, black emphasis ON/OFF may be selected according to an input medium. In this case, after the operator operates the operating unit 3 for displaying an image adjustment mode screen (not shown) on the display unit 9, a screen, for example shown in FIG. 4, is shown. Then, by operating the operating unit 3, the setting of black emphasis ON/OFF is preliminarily performed for each medium.

Further, preferably, in the case of using a negative film, a reversal film, P to P and a digital camera, black emphasis is preferably ON in consideration of the “black reproduction” problem, and in the case that an image and letters are synthesized in a medium, black emphasis is preferably OFF in consideration of not having too much of “blur” in the letters. By preliminarily performing such settings, it is possible to obtain a suitable print on which “black reproduction” is well adjusted in the case of using a negative film, a reversal film, P to P and a digital camera, and it is possible to obtain a suitable print without too much of “blur” in the case that an image and letters are synthesized in a medium.

Thereafter, when an image data is inputted from the image inputting unit, the image processing unit 13 performs a predetermined process such as “image enhancement” or the like to the image data according to necessity, and the processed image data is outputted to the output-use image processing unit 22. The control unit 2 recognizes a type of an input medium, and outputs an LUT changing signal for turning black emphasis mode ON/OFF to the LUT storing unit 21. When the LUT storing unit 21 receives the LUT changing signal, the LUT storing unit 21 transmits an LUT to the output-use image processing unit 22, and the LUT in the LUT storing area of the output-tise image processing unit 22 is changed. When the operator operates the operating unit 3 for an operation of printing the image data, the output-use image processing unit 22 and the exposure-development processing unit 23 perform applicable predetermined processes, and a print recorded on the silver halide color photosensitive material is outputted to the tray 12.

In this way, it is possible to easily obtain a high-quality print without too much of “blur” and on which “black reproduction” is well adjusted, for each medium.

Further, the change of an LUT may be done for each image unit to be printed. In this case also, when the image data is inputted from the image inputting unit, the image processing unit 13 performs a predetermined process such as “image enhancement” or the like according to necessity, and outputs the processed image data to the output-use image processing unit 22. Thereafter, by operating the operating unit 3, an image adjusting mode selection screen (not shown) is displayed on the displaying unit 9, and then a screen, for example shown in FIG. 5, is displayed.

Then, the operator selects an area in which a desired image is displayed with the cursor button SC3, and after the image quality adjusting button SC4 is operated for “image enhancement”, by operating the black emphasis button SC7, an information indicating that OF/OFF of black emphasis concerning image data of the selected area is assigned is stored. Then, an existence of an assignation of black emphasis is displayed on a black emphasis assignation confirming unit 52. Further, with respect to an unnecessary image, an adjustment of turning black emphasis ON/OFF may not be performed by selecting the PASS button SC5.

After such operations are performed on each image data, the size/page assigning button SC1 and the print button SC6 are operated for starting the print.

At this time, based on the information indicating that ON/OFF of black emphasis is assigned is stored for each image data, the control unit 2 outputs the LUT changing signal to the LUT storing unit 21 of the image recording unit 14 for each image data, and the LUT of the output-use image processing unit 22 is changed. Thereby, under a condition in which ON/OFF of black emphasis is assigned for each image data, an exposure and a development are performed, and thereby it is possible to sequentially obtain high-quality prints for each image data without too much of “blur” and on which “black reproduction” is well adjusted.

When there is a next page confirmed according to the display portion SC8, the same operation is performed to the next page. When the printing of all image data is completed, the display returns to a reception screen.

Further, in the above, only two steps of switching between ON and OFF of black emphasis are performed. However, by preparing a plurality of LUTs and by adjusting a density at a plurality of steps, it is possible to do the more-detailed adjustment.

In this case, for example, in order to adjust an image data in consideration of a density continuity, a series of LUTs shown in FIGS. 8A to 8D, which have a fixed maximum density while a non-fixed density area is changed are prepared, or in order to do the adjustment in consideration of not changing an image quality of the fixed density area, a series of LUTs shown in FIGS. 8A, 8E and 8F are prepared. Further, an LUT(s) may be arbitrarily selected among a series of LUTs shown in FIGS. 8A to 8F.

Further, in the example of the above-mentioned case, an LUT in which only a high density portion is changed is described as an example. However, an LUT to be changed in the present invention is not limited to the LUT in which a high density portion is changed, and it is possible to change any portion in the entire area of the LUT. For example, as shown in FIGS. 9A and 9B, an image quality may be adjusted by changing an LUT in which a density area of a low density portion side is changed.

Further, in the above-mentioned example, with a plurality of LUTs preliminarily prepared, an LUT is changed by selecting one (or more) among the prepared LUTs. However, an LUT may be changed by a calculation or the like based on a specific LUT.

As mentioned, according to the invention relating to the present embodiment, since the LUT is changed by an operation of the operator on the image recording unit 14 or is changed automatically by the control unit 2, without losing a generality of a general-purpose image data generated by the image processing unit 13, it is possible to operate a density of the image data according to properties of the image recording unit 14.

Further, for example in a specific density portion such as a high density portion, since only a portion is substantially changed in an LUT for changing only a desired density range, it is possible to change a desired density range without deteriorating an image quality.

Further, since densities of not less than two colors are changed by changing LUTs, it is possible to obtain a high-quality print while a color balance of the image is suitably maintained. In particular, when an LUT before the change is changed to an LUT in which only a high density portion is different with a color balance thereof maintained, it is possible to adjust well in “black reproduction” under black emphasis ON, or it is possible to reduce “blur” of letters or the like under black emphasis OFF.

Further, by changing an LUT to an LUT in which only values of a high density portion are different, it is possible to reduce “blur” of black without deteriorating an image quality.

Further, even though there is a problem of generating a density unevenness or a density variation in a high density portion according to a property of when a recording is done on a silver halide color photosensitive material, by changing an LUT in an image recording step with an easy operation, the problems of “black reproduction” and “blur” are solved, whereby it is possible to obtain a high-quality print.

Further, in a thermal transfer printer, there are problems such as: when a heating power is large, a life duration of a recording head becomes short; and in the case of having a large heating power, when a next print is started before a temperature does not sufficiently fall down, since a density of the next print becomes high due to the heat history, it is necessary to have a certain interval between the prints, thereby it takes longer time to continuously perform the prints; and the like. However, by performing the print at a suitable density by changing an LUT in the output-use image processing unit, it is possible to extend a life duration of the recording head by suppressing a heat at a necessary level, without losing the generality of the image data. Further, since a time necessary for making a temperature fall down is shortened by suppressing heating power, it is possible to shorten a time for continuously printing.

Further, since it is possible to make a selection among a plurality of LUTs, for example, by preparing a plurality of LUTs each having a different range in which a density is to be changed while a maximum density thereof is fixed, an LUT optimal to a scene can be selected among the LUTs in consideration of a density continuity. Alternatively, by preparing a plurality of LUTs each having the same density from which the change of an LUT is started and having a different range in which a density is to be changed, an LUT optimal to a scene can be selected among the LUTs in consideration of an image quality. In other words, it is possible to perform a detailed adjustment of an image according to a scene and a purpose of the adjustment.

Further, it is possible to adjust a density by changing an LUT according to properties of an image data of each input medium. For example, when an input medium having a low possibility of including a letter image, such as a negative film, is used, since it is necessary to consider the matter of “black reproduction”, an LUT is changed to an LUT in which a density of a high density portion is increased. On the other hand, when an input medium having a high possibility of including a letter image, such as a PC card or the like, since it is necessary to consider the matter of “blur” problem, an LUT is changed to an LUT in which a density of a high density portion is decreased. In other words, since it is possible to change an LUT to the LUT corresponding to properties of each input medium, it is possible to obtain a high-quality print with respect to each input medium.

Next, a second embodiment of the present invention will be described. However, what differentiates the second embodiment from the above-described first embodiment are only a control by the control unit 2 and not displaying the black emphasis mode selection screen on display unit 9, and the other structures are common between the first embodiment and the second embodiment. In the second embodiment, descriptions will be made with emphasis in the control unit 2, and the descriptions of the structures identical to that of the first embodiment are omitted.

The control unit 2 identifies a content of the image data inputted from the film scanner unit 4 and the like for classifying the images, and outputs the LUT changing signal based on the classification result for changing the LUT. As a concrete example of identifying the image data, an example of identifying a scene attribute is described hereafter.

First, an image data is inputted from the film scanner unit 4 and the like, and a subject pattern is extracted from the image data. Here, for example, what are preliminarily stored in the control unit 2 are combinations such as: a subject pattern of “Bride/Groom/Face/Dress/Spotlight” for “Bridal Banquet”; a subject pattern of “Face/People in Uniform/Historical Architecture (Japanese Architecture)” for “Excursion in Kyoto”; and the like, according to an extraction pattern. The control unit 2 selects the preliminarily-stored combination from the extracted subject pattern.

Then, a scene attribute is determined, by taking an information into account when there is such an information that can be obtained from the input medium. Further, when a tendency of a scene attribute of the processed images that a client has ordered in the past is stored in the control unit 2, a scene attribute is determined also by taking the tendency into account. When there is none of these information and tendency, a scene attribute is determined from the extracted subject pattern.

Here, the scene attribute means a main purpose of the photograph. For example, a trip photograph, an outdoor photograph, an event photograph, a nature photograph, a portrait and the like can be cited as the scene attribute.

Further, the subject pattern means a specific, recognizable, separable subject existing in an image, such as a person, a person wearing a specific clothing (uniform of a sport or the like), an architecture (Japanese, occidental, modern, historical, religious and the like), cloud, blue sky, ocean and the like.

Further, a method of extracting the subject pattern is not in particular limited as long as the method is capable of extracting the above-mentioned subject pattern. For example, it is possible to use a known method such as a template matching or the like.

Then, the control unit 2 changes an LUT to the LUT corresponding to the scene attribute determined as mentioned above. Here, the changed LUT may be calculated according to the LUT before the change.

Next, an operation of the second embodiment of the present invention will be described based on a flowchart illustrated in FIG. 11.

When an image data is inputted from one of the film scanner unit 4 and the like (S11), the image data is transmitted to the image processing unit 13 (S12). Then, after the processes that are the same as the first embodiment are applied to the image data, the image is displayed on the display unit 9, and also the image data is transmitted to the output-use image processing unit 22 (S13). Then, based on the image data transmitted to the image processing unit 13, the control unit 2 identifies a scene attribute according to the above-mentioned method and classifies the image (S14). Based on the classification result, the LUT changing signal is outputted to the LUT storing unit 21 (S15). Then, similarly to the mentioned first embodiment, the LUT is transmitted to the output-use image processing unit 22 (S16), the LUT corresponding to the LUT changing signal is changed to the LUT outputted from the LUT storing unit 21 (S17), and thereafter exposure and development are performed (S18).

As above, according to the invention relating to the present embodiment, when it is possible to identify a scene attribute from the image data, that is, it is possible for the operator or the control unit 2 automatically to identify a content of the image data, and to classify the image, it is possible to change an LUT to a suitable LUT. Therefore, it is possible to obtain a high-quality print without too much of “blur” and on which “black reproduction” is well adjusted.

Next, a third embodiment of the present invention will be described. However, what differentiates the third embodiment from the above-described first embodiment are only a control by the control unit 2 and not displaying the black emphasis mode selection screen on display unit 9, and the other structures are common between the first embodiment and the third embodiment. In the third embodiment, descriptions will be made with emphasis in the control unit 2, and the descriptions of the structures identical to that of the first embodiment are omitted.

The control unit 2 identifies an information such as a letter, an image or the like, in the image data inputted from the film scanner 4 or the like, and outputs the LUT changing signal based on the identification result for changing an LUT.

As a method of identifying the image, for example, by dividing a certain area into blocks and taking out an image information, a process for identifying whether the image is a half tone image (picture) or a binary image (letters including line drawing) is performed, and next, based on the identified picture/letter information, information amount of picture/letter is calculated and whether the image information largely includes the information of picture/letter is identified.

Then, further an identification is performed based on whether the rate of letter information is not more than a predetermined rate, whether the rate of picture information is not less than a predetermined rate or the like, for classifying the image. Then, according to a result of the image classification, an LUT is changed to the LUT stored in the LUT storing unit 21. For example, an image identified to have a large letter rate will be set to have black emphasis OFF, whereby it is possible to obtain a print with the occurrence of “blur” suppressed and on which “black reproduction” is well adjusted. Conversely, an image identified to have a large picture rate will be set to have black emphasis ON, whereby it is possible to obtain a print on which “black reproduction” is well adjusted.

Here, the changed LUT may be calculated from the LUT before the change. This can also be applied to the fourth to ninth embodiments, which will be described later.

As above, according to the invention relating to the present embodiment, a content of the image data is automatically identified for classifying the image data, and it is possible to change an LUT to a suitable LUT by obtaining an information necessary for adjusting a density according to the classification. Therefore, it is possible to obtain a high-quality print without too much of “blur” and on which “black reproduction” is well adjusted.

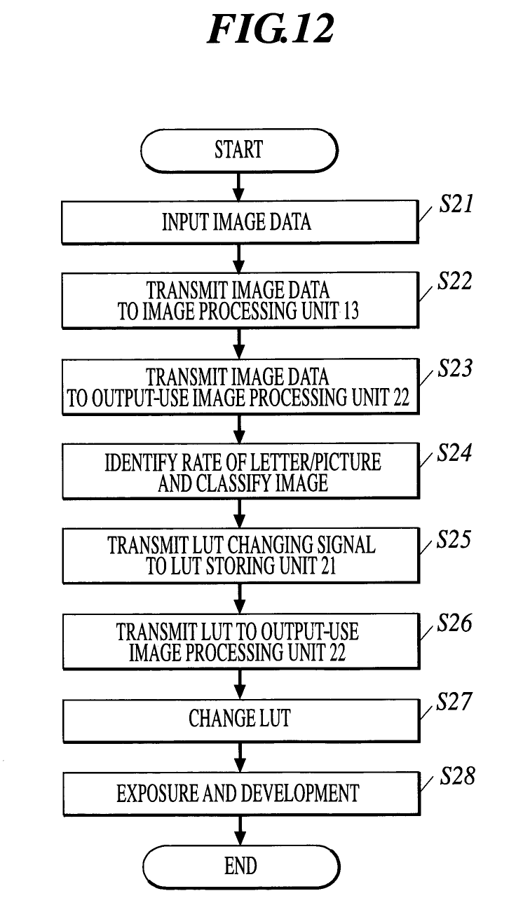

Next, an operation of the third embodiment of the present invention will be described based on a flowchart illustrated in FIG. 12.

When an image data is inputted from one of the film scanner unit 4 and the like S21), the image data is transmitted to the image processing unit 13 (S22). Then, after the processes that are the same as the first embodiment are performed to the image data, the image is displayed on the display unit 9, and also the image data is transmitted to the output-use image processing unit 22 (S23). Then, based on the image data transmitted to the image processing unit 13, the control unit 2 identifies a rate of letter/picture for classifying the image (S24). Based on the classification result, the LUT changing signal is outputted to the LUT storing unit 21 (S25). Then, similarly to the described first embodiment, the LUT is outputted to the output-use image processing unit 22 (S26), the LUT corresponding to the LUT changing signal is changed to the LUT outputted from the LUT storing unit 21 (S27) and thereafter an exposure and a development are performed (S28).

As above, according to the invention relating to the present embodiment, by identifying the rate of a letter and a picture in the image data in the control unit 2 according to the mentioned method, it is possible to change an LUT to a suitable LUT according to the rate of a letter and a picture of the image data. Therefore, it is possible to obtain a high-quality print without too much of “blur” and on which “black reproduction” is well adjusted.

Next, a fourth embodiment of the present invention will be described. However, what differentiates the fourth embodiment from the first embodiment is only a screen displayed on the display unit 9, and the other structures are common between the first embodiment and the fourth embodiment. In the fourth embodiment, descriptions will be made with emphasis in the display unit 9, and the descriptions of the structures identical to that of the first embodiment are omitted.

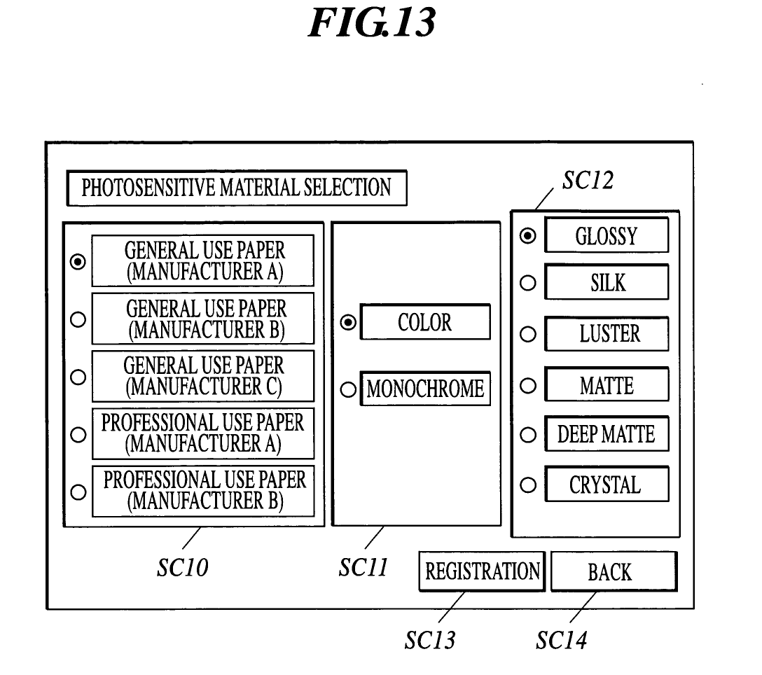

On the display unit 9, for example, a screen for selecting a type of a photosensitive material being a setting information as shown in FIG. 13 is displayed. On the screen, a check box SC10 is provided for selecting whether a general use paper or a professional use paper, for example, among a general use paper (manufacturer A), a general use paper (manufacturer B), a general use paper (manufacturer C), a professional use paper (manufacturer A) and a professional use paper (manufacturer B), in view of variety.

Further, in order to make it possible to select whether color or monochrome in view of variety, a check box SC11 is provided.

Furthermore, it is also possible to make a selection in view of a finishing surface type of a photosensitive material, and a check box SC12 is provided for selecting one among glossy, silk, luster, matte, deep matte and crystal. Further, a registration button SC13 for registering a setting selected by an operator, and a back button SC14 for returning to the previous screen are provided.

Then, when an operator operates the operating unit for selecting a type of a photosensitive material and confirms the selected content with the registration button SC13, an LUT is changed to an LUT optimal to the type of a photosensitive material selected by the operator.

The above-mentioned professional use paper is a printing paper which in general has more coating amount of silver halide emulsion than an amateur use paper. An optimal time of the photosensitive material for development differs depending on amount of coated silver halide emulsion, and therefore, in general, it is necessary to make a development time longer for clearly coloring a high density portion when large amount of silver halide emulsion is coated. Further, density properties of a high density portion differ depending on coated amount of silver halide emulsion.

Therefore, in consideration of properties of the photosensitive material, for example, black emphasis ON or OFF of the LUT is changed and a conveyance speed of the printing paper in the development processing unit is changed. Thereby, it is possible to obtain a high-quality print without too much of “blur” and on which “black reproduction” is well adjusted.

In other words, the professional use paper has a characteristic of being capable of clearly coloring in a high density portion by making a development time longer than the amateur use paper. Therefore, when the professional use paper is used, by making a conveyance speed in the development processing unit slower than that of the amateur use paper, it is possible to suitably do the coloring in a high density portion.

Here, there are cases in which density properties of a high density portion are different, such as the case that amount of silver halide emulsion is different between the professional use paper and the amateur use paper, depending on a manufacturer. Therefore, by seeing a screen as shown in FIG. 13, even among the same professional use papers or the same general use papers, it is possible to select one according to a manufacturer.

As a type of the photosensitive material, since an LUT for coloring in a high density portion is different depending on, for example, whether the photosensitive material is a photosensitive material for a color print or a photosensitive material for a monochrome print, a color selection button SC16 and a monochrome selection button SC17 are provided for selecting an optimal LUT for each.

Further, coloring properties in a high density portion are different depending on a finishing surface type of the photosensitive material. For example, with a default setting of black emphasis OFF, when the printing is performed on the photosensitive material, although the glossy type does not have a problem, the silk type has a problem of not suitably adjusting “black reproduction” because the high density portion appears as a portion having a low density on the print. Therefore, when the photosensitive material is silk, the operators selects the silk on the screen by operating the operating unit 3. Then, an LUT is changed to the LUT stored in the LUT storing unit 21 which emphasizes black when the printing is performed on the silk, and it is possible to obtain a print on which “black reproduction” is well adjusted.

Here, the above-mentioned glossy means “gloss smooth surface”, the silk means “half-gloss smooth silk surface”, the luster means “half-gloss particulates surface”, the matte means “half-gloss smooth surface”, the deep matte means “non-gloss smooth surface”, and the crystal means “super gloss”.

In the above, described is the case that the operator selects a type of the photosensitive material on the display of the screen. However, a magazine (not shown) connected to the exposure-development processing unit 23 may identify an information regarding a type of the photosensitive material. For example, a displaying section is provided at an outside wall of the magazine, the displaying section being capable of reading an information of the photosensitive material that is contained in the magazine, and further a display reading section is provided with the exposure-development processing unit 23 to which the magazine is connected. Then, when the magazine is connected to the exposure-development processing unit 23, the display reading section reads from the display section, an information of the photosensitive material contained in the magazine, and the information is transmitted to the control unit 2. Thereby, the control unit 2 outputs the LUT changing signal to the LUT storing unit 21 of the image recording unit 14 at the time of the development, and the LUT of the output-use image processing unit 22 is changed to an LUT appropriate to the paper contained in the magazine.

Further, at another predetermined position of the outside wall of the magazine, a width displaying section (not shown) for displaying a width of the contained photosensitive material may be provided. The magazine used here is portable while the photosensitive material is put in a dark room state. For example, a roll magazine having approximately a cuboid shape containing a roll of the photosensitive material, or the like can be used as the magazine.

Here, on the screen shown in FIG. 13, it is possible to select a type of the photosensitive material and a finishing surface type, respectively. However, it is not necessary to make it possible to make a selection with respect to all of these elements. For example, it may be only possible to select whether the professional use paper or the amateur use paper, or it may be only possible to select whether the photosensitive material for a color print or the photosensitive material for a monochrome print.

Further, in the present embodiment, described is the case that a setting is changed on the screen after the image data is inputted. However, a setting may be changed before the image data is inputted. This can also be applied to the fifth embodiment.

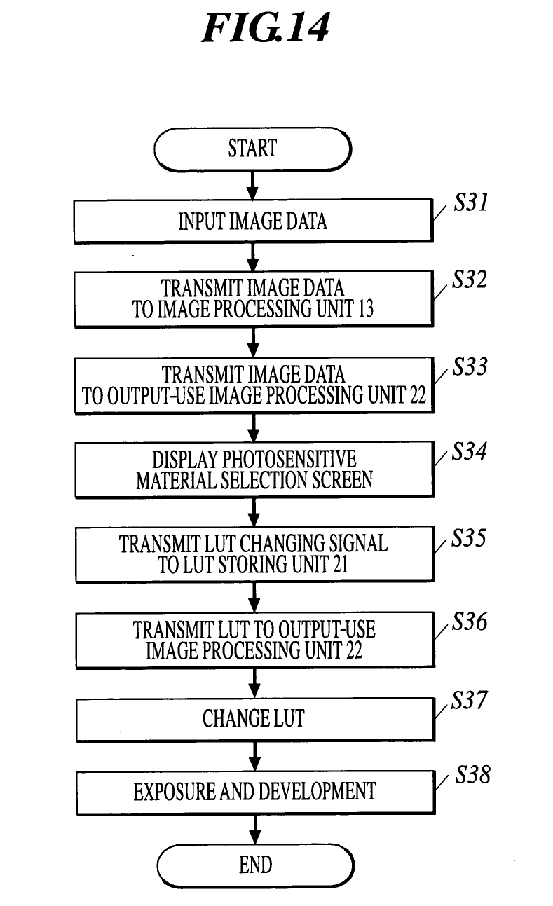

Next, an operation of the fourth embodiment of the present invention will be described based on a flowchart illustrated in FIG. 14.

When an image data is inputted from one of the film scanner unit 4 and the like (S31), the image data is transmitted to the image processing unit 13 (S32). Then, after the processes that are the same as the first embodiment are performed, the image is displayed on the display unit 9, and the image data is also transmitted to the output-use image processing unit 22 (S33).

Next, an operator operates the operating unit 3 for inputting an operating signal for displaying a screen for selecting a type of the photosensitive material as shown in FIG. 13 for example (S34), and further the operator operates the operating unit 3 for selecting a type among the types of the photosensitive material displayed on the screen. Then, when the registration button SC24 is pushed, an operating signal for changing the LUT to an LUT optimal to the selected finishing surface type is outputted to the control unit 2, and the control unit 2 outputs the LUT changing signal to the LUT storing unit 21 of the image recording unit 14(S35).

Then, after the processes that are the same as the first embodiment are performed, a print recorded on a silver halide color photosensitive material is outputted to the tray 12 (S36 to S38).

As above, according to the invention relating to the present embodiment, by adjusting a high density portion by changing an LUT according to a type of the photosensitive material, which is a setting information, it is possible to obtain a print without too much of “blur” and on which “black reproduction” is well adjusted.

Further, when getting automatically an information of the photosensitive material that is contained in the magazine in place of operator's inputting, it is possible to obtain a print without too much of “blur” and on which “black reproduction” is well adjusted.

Next, a fifth embodiment of the present invention will be described. However, what differentiates the fifth embodiment from the above-described first embodiment is only the screen displayed on the display unit 9, and the other structures are common between the first embodiment and the fifth embodiment. In the fifth embodiment, descriptions will be made with emphasis in the display unit 9, and the descriptions of the structures identical to that of the first embodiment are omitted.

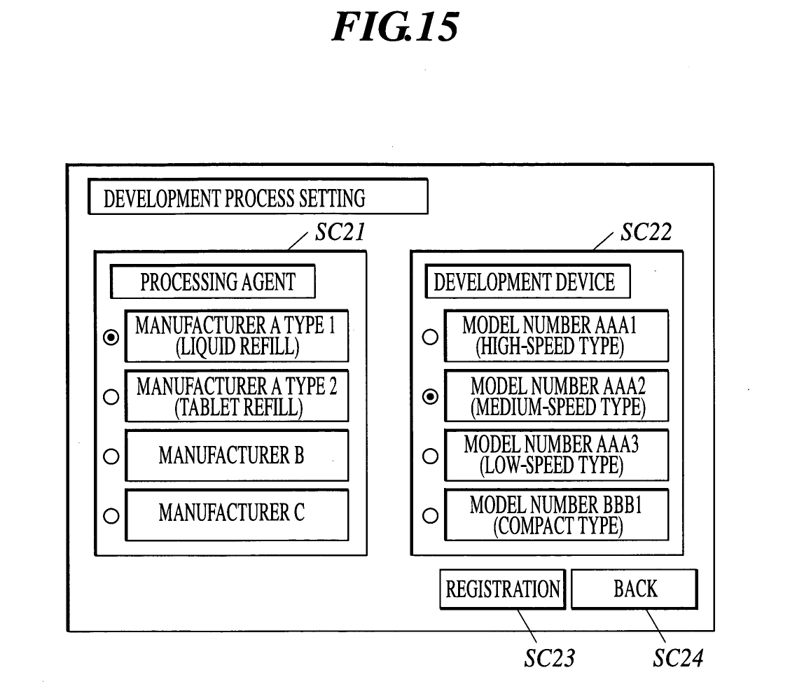

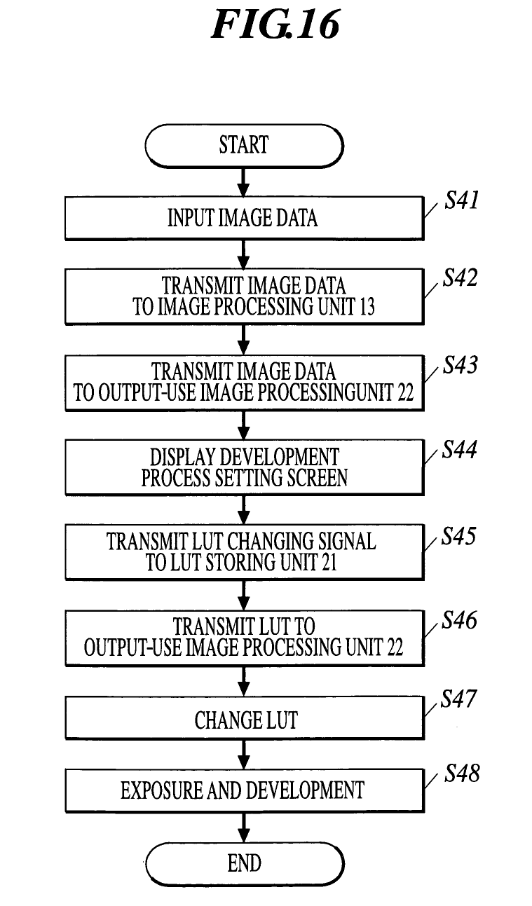

On the display unit 9, for example, a screen for selecting a type of a development that is a setting information shown in FIG. 15 is displayed. On this screen, a type of a processing agent and a type of a development device are displayed, and it is possible for an operator to select a processing agent and a development device to be used for printing the image data by operating the operating unit 3. On this screen, a check box SC21 is provided for selecting a processing agent among Manufacturer A Type 1, Manufacturer A Type 2, Manufacturer B and Manufacturer C.

Further a check box SC22 is provided for selecting a development device among AAA1, which is a high-speed type, AAA2, which is a medium-speed type, AAA3, which is a low-speed type, and BBB1, which is a compact type. Further a registration button SC23 is provided for registering the setting selected by the operator, and a back button SC24 is provided for returning to the adjustment screen.

Then, when the operator operates the operating unit 3 for selecting a processing agent and a development device displayed on the screen, the LUT changing signal is outputted to the LUT storing unit 21, according to the combination of the selected processing agent and the selected development device, an LUT with which it is possible to print the image data without too much of “blur” and on which “black reproduction” is well adjusted is transmitted to the output-use image processing unit 22. An LUT is changed to the LUT transmitted to the output-use image processing unit 22, and after a predetermined process is performed to the image data by the exposure-development processing unit 23, a print on which black is emphasized can be obtained.

When types of developers to be used for the development are different, there is a case of having a difference in a density on the print when the printing is performed, especially a difference of density properties in a high density portion.

Further, there is a case in which density properties of the print are different depending on a type of the development device. The development in general comprises steps of developing, fixing, rinsing and the like, and the printing paper is conveyed to the next step after being soaked within a predetermined liquid in each step (for example, soaked within a developer in the developing step). Then, when the printing paper is conveyed from one step to another (hereinafter, a state of when the printing paper is conveyed from one step to another step is called “transition”), the film is exposed to air. When a type of the development device is different, a time period for soaking the printing paper in the predetermined liquid in the development device and a time period for “transition” may be different from that of another type of the development device, and therefore there is a case in which a density on the print, especially a density of a high density portion is affected.

Therefore, in consideration of properties of a type of the development, that is, properties of the developer and the development device to be used, for example, by changing the LUT between black emphasis ON and black emphasis OFF, it is possible to obtain a print without too much of “blur” and on which “black reproduction” is well adjusted.

Further, the exposure-development processing unit 23 may be formed so as to unite a portion for the exposure and a portion for the development. However, the exposure-development processing unit may be formed by any combination of an exposure device and a development device, which are provided separately. Therefore, even in the same digital minilab, there are a case of using a development device performing a high-speed development and a case of using a development device performing a low-speed development. Therefore, it is necessary to change the LUT also in consideration of a type of the development device.

Here, selecting the LUT that is optimal to the development device may not be performed by an operation of an operator by him/herself as mentioned, but it may be performed automatically by the control unit 2. For example, by providing a display unit at the outside wall of the development device, the display unit being capable of reading an information of the development device, further by providing a display reading unit at an exposure unit to which the development device is connected, and by reading a time period within which the photosensitive material is in the liquid in the development device and a time period of “transition”, selecting the LUT optimal to the development device may automatically be performed by the control unit 2.

Similarly, by reading an information from the development device, the LUT optimal to the developer to be used may be selected.

Next, an operation of the fifth embodiment of the present invention will be described based on a flowchart illustrated in FIG. 16.

When an image data is inputted from one of the film scanner unit 4 and the like (S41), after the image data is outputted to the image processing unit 13 (S42), and after the processes that are the same as the first embodiment are performed, the image is displayed on the display unit 9, and also transmitted to the output-use image processing unit 22 (S43).

Next, an operator operates the operating unit 3 to input an operation signal for displaying a screen such as one shown in FIG. 15 on display unit 9 (S44), and further the operator operates the operating unit 3 to select one of the developers displayed on the screen and to select one of the development devices displayed on the screen, respectively. Further, when the operator pushes the registration button 33, the operating signal for changing an LUT to the LUT optimal for printing by using the selected developer and the selected development device is outputted to the control unit 2, and the LUT changing signal is outputted to the control unit 2 to the LUT storing unit 21 of the image recording unit 14 (S45).

Then, after the processes that are the same as the first embodiment are performed, the print recorded on the silver halide color photosensitive material is outputted to the tray 12 (from S46 to S48).

As described above, according to the invention relating to the present embodiment, by changing the LUT according to a type of the development, which is a setting information, to adjust a high density portion, it is possible to obtain a print without too much of “blur” and on which “black reproduction” is well adjusted.

Next, a sixth embodiment of the present invention will be described. However, what differentiates the sixth embodiment from the described first embodiment is only the control unit 2, and the other structures are common between the first embodiment and the sixth embodiment. In the sixth embodiment, descriptions will be made with emphasis in the control unit 2, and the descriptions of the structures identical to that of the first embodiment are omitted.

The control unit 2 counts development process amount (size and page number of the print) for changing the LUT according to the development process amount during a predetermined period.

At the time of printing, according to the development process amount during a predetermined period, density properties, especially density properties of a high density portion are changed depending on a type of the developer. Therefore, first, a measurement of how density properties are changed according to development process amount is preliminarily performed for each type of a developer, a fixer and the like. Then, according to a data of the development process amount transmitted from the exposure-development processing unit 23 (will be described later), for example, based on the state of the developer at this point or the like, the LUT is changed between black emphasis ON and black emphasis OFF. Thereby, it is possible to obtain a print on which “black reproduction” is well adjusted.

Here, in the present embodiment, the control unit 2 automatically sets black emphasis ON or OFF based on an operating state information. However, an operator may set black emphasis ON or OFF by operating the operating unit 3 based on the operating state information that is printed out or displayed on the display unit 9.

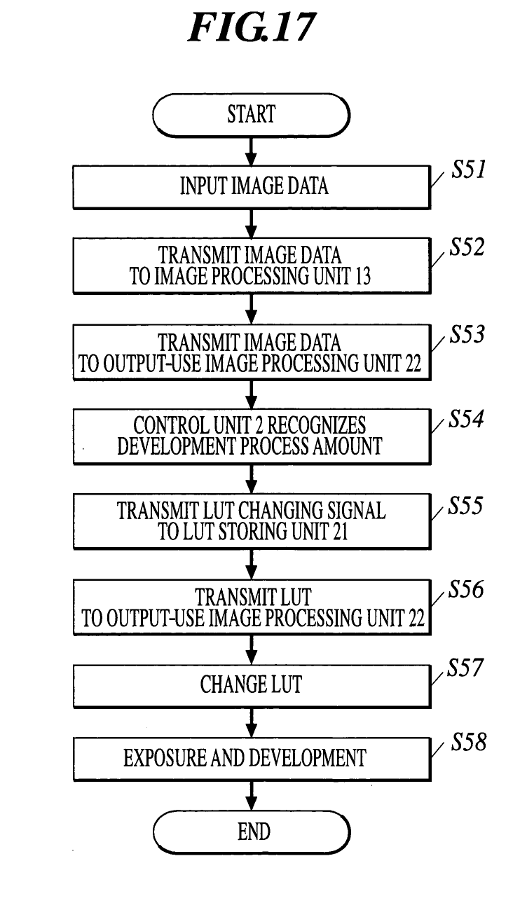

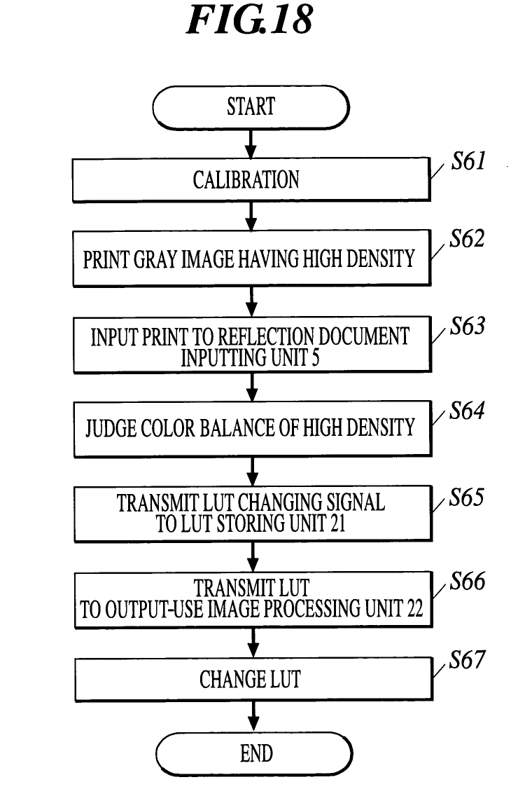

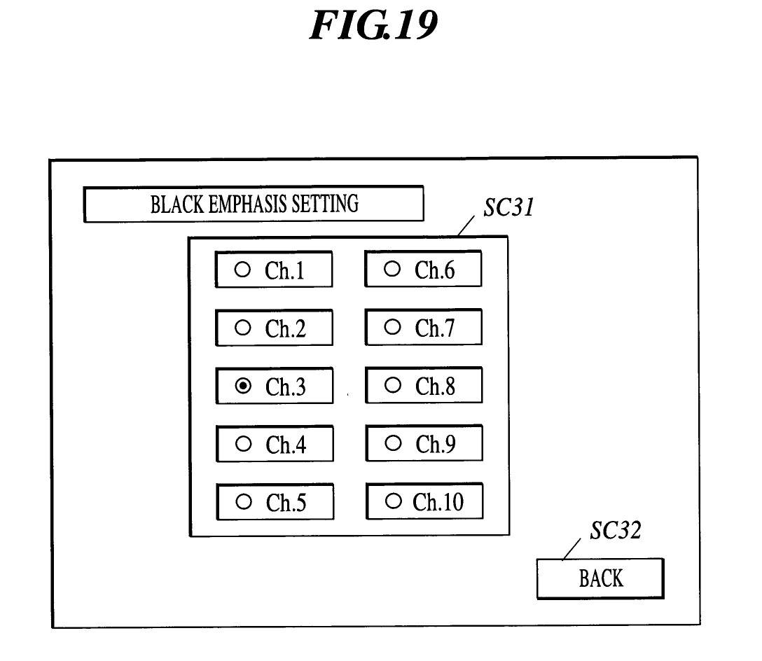

Next, an operation of the sixth embodiment of the present invention will be described based on FIG. 17.

When an image data is inputted from one of the film scanner unit 4 and the like (S51), the image data is outputted to the image processing unit 13 (S52). Then, after the processes that are the same as the first embodiment are performed, the image is displayed on the display unit 9, and also transmitted to the output-use image processing unit 22 (S53).

The control unit 2 recognizes development process amount (S54), and the LUT changing signal is outputted to the LUT storing unit 21 of the image recording unit 14 so as to change an LUT to the LUT optimal to perform the print according to the count (S55).

Then, after the processes that are the same as the first embodiment are performed, the print recorded on the silver halide color photosensitive material is outputted to the tray 12 (from S55 to S58).

As described above, according to the invention relating to the present embodiment, by changing the LUT according to an operating state information for adjusting a high density portion, it is possible to obtain a high quality print without too much of “blur” and on which “black reproduction” is well adjusted.

Next, a seventh embodiment of the present invention will be described. However, what differentiates the seventh embodiment from the described first embodiment is only the control unit 2, and the other structures are common between the first embodiment and the seventh embodiment. In the seventh embodiment, descriptions will be made with emphasis in the control unit 2, and the descriptions of the structures identical to that of the first embodiment are omitted.

The control unit 2 changes the LUT according to a measurement result of a gray print for a high density portion, the measurement result being inputted from the reflection document inputting unit 5 (will be described later). Here, the control unit 2 applies the change to the LUT that is prepared according to a type of a preset color balance of a high density, according to an input result. Further, by displaying the input result as a value or the like, an operator may select an appropriate LUT to be changed according to the display.

A development property, which is one of the operating states, is varied daily (development variation). In response to the variation, a calibration is normally performed before the use. For example, a gray image of an intermediate density is printed and its print is inputted, for example from the reflection document inputting unit 5, for measuring a density. Then, based on the measurement result, exposure amount is adjusted to perform the calibration. However, in the high density portion, the adjustment of the exposure amount is often insufficient. Especially when the image involves a problem of the black emphasis, the development variation has a prominent influence on the print. Therefore, by printing a gray image having a high density, the print is for example inputted from the reflection document inputting unit 5 for measuring the density, and based on the measurement result, the LUT is changed to provide a different black emphasis degree.

Next, an operation of the seventh embodiment of the present invention will be described based on a flowchart of FIG. 18.

First, the calibration is performed (S61). Thereafter, a gray image having a high density is printed (S62), the print of the gray image having the high density is inputted from the reflection document inputting unit 5 (S63), and the control unit 2 judges a color balance of the high density (S64).

Then, when the image data is inputted, the control unit 2 outputs the LUT changing signal corresponding to the judgment result to the LUT storing unit 21 (S65). In response to the input of the LUT changing signal, the LUT storing unit 21 outputs the LUT corresponding to the LUT changing signal to the output-use image recording unit 22 (S66), as well as the described first embodiment. In the output-use image recording unit 22, an LUT is changed to the LUT outputted from the LUT storing unit 21 (S67).

As described, according to the invention relating the present embodiment, the LUT is changed for adjusting a high density portion according to the change of the development property, which is one of the operating state information. Thereby, it is possible to obtain a high quality print without too much of “blur” and on which “black reproduction” is well adjusted.

Next, an eighth embodiment of the present invention will be described. However, what differentiates the eighth embodiment from the described first embodiment is only the screen, and the other structures are common between the first embodiment and the eighth embodiment. In the eighth embodiment, descriptions will be made with emphasis in the display unit 9, and the descriptions of the structures identical to that of the first embodiment are omitted.

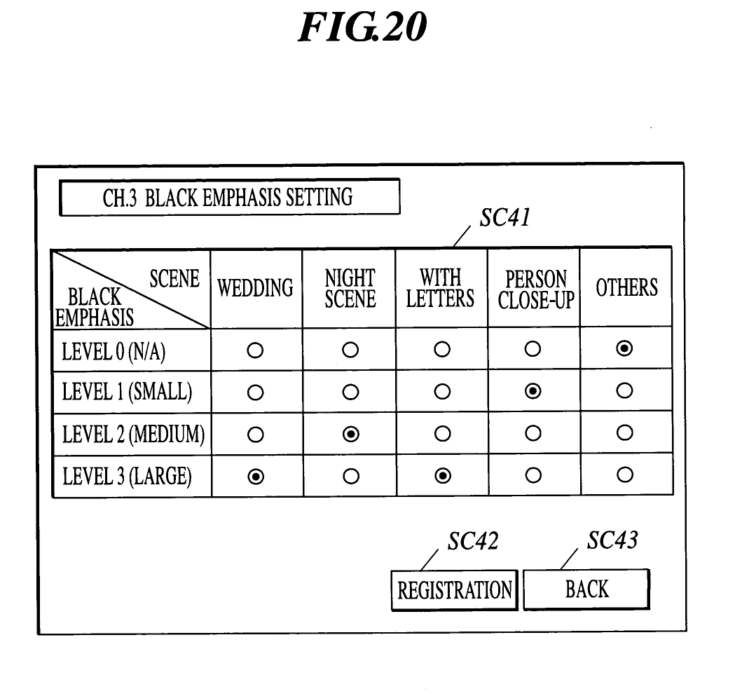

On the display unit 9, for example, a screen is displayed for performing a customization by registering and changing a setting value at the time of setting black emphasis, and by performing a detailed setting according to a type of the image data, as shown in FIG. 19. On the screen, a check box SC31 comprising a plurality of channels is provided for setting the black emphasis in detail according to the image data, and it is possible for an operator to select any channel for the setting. Further, a “BACK” button SC32 is provided for suspending a black emphasis setting. When the operator selects the channel 3 (Ch. 3), for example, a screen on which it is possible to select a degree to emphasize black for each scene is displayed, as shown in FIG. 20. On this screen, as selectable scenes, WEDDING, NIGHT SCENE, WITH LETTERS, PERSON CLOSE-UP and OTHERS are provided. Then, for each scene, a check box SC41 is provided for setting a black emphasis degree according to user's preference among four degrees that are LEVEL 0 (N/A), LEVEL 1 (SMALL), LEVEL 2 (MEDIUM) and LEVEL 3 (LARGE).

Here, although the check box SC31 comprises ten channels, the number of channels thereof is not limited to ten. The number of channels may be larger or smaller than ten.

At the check box SC41 shown in FIG. 20, respective settings are done to the items of “WEDDING”, “NIGHT SCENE”, “WITH LETTERS”, “PERSON CLOSE-UP” and “OTHERS”. When a channel other than the channel 3 is selected in the check box SC31, it is possible to do a setting different from the case of the channel 3, with respect to a part of or all of the check boxes shown in FIG. 20.

Then, these setting can also be changed by displaying the screen shown in FIG. 20 and by operating the operating unit 3.

Further, on this screen, a registration button SC42 is provided for registering the setting selected by the operator and a back button SC43 is provided for suspending a black emphasis setting. When the operator does the setting of the check box SC41 and a content of the setting is registered with the registration button SC42, an LUT is changed according to the content of the setting.

Further, the above-described screen that is shown when the channel is selected is not limited to the screen shown in FIG. 20. For example, the setting may be changed by displaying the screen shown in FIG. 3 or by displaying the screen shown in FIG. 4.

Next, an operation of the eighth embodiment of the present invention will be described.

The operator operates the operating unit 3 to input an operating signal and to display a black emphasis setting as shown in FIG. 19, and further the operator operates the operating unit 3 to select a predetermined channel among the plurality of channels displayed on the screen and pushes the registration button SC42 to confirm the selected content. Then, a content of the channel shown in FIG. 20 is displayed, and the operator operates the operating unit 3 to change a channel setting in the check box SC41 according to user's preference or the like, and thereafter the operator pushes the registration button SC42 to confirm the setting content.

As above, according to the invention relating to the present embodiment, it is possible to preliminarily register a plurality of conditions that are expected according to an image data to be printed. For example, by only operating a screen according to user's preference, it is possible to easily change the setting.

Further, since it is possible to preliminarily provide a plurality of expected setting conditions with respect to each channel, it is not necessary for the operator to perform a complicated operation of re-performing all the settings at each printing operation. Therefore, it is possible to change a plurality of settings by only selecting a channel.

Next, a ninth embodiment of the present invention will be described. However, what differentiates the ninth embodiment from the above-described first embodiment is only the screen and the other structures are common between the first embodiment and the ninth embodiment. In the ninth embodiment, descriptions will be made with emphasis in the display unit 9, and the descriptions of the structures identical to that of the first embodiment are omitted.

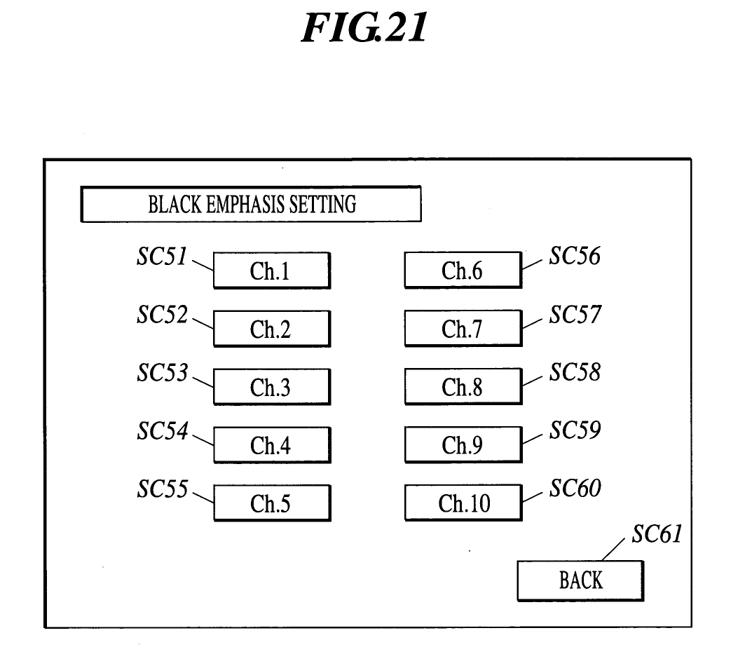

On the display unit 9, for example, a screen shown in FIG. 21 is displayed for selecting a channel. On this screen, buttons SC51 to SC60 are provided for performing a black emphasis setting in detail with respect to each of a plurality of channels 1 to 10 according to the image data. Then, “back button” SC61 is provided for returning to a previous screen.

According to this screen, for example, by selecting a channel, it is possible to directly select a preset content such as a content of the setting shown on the screen of FIG. 3, FIG. 4 or FIG. 20 described in the eighth embodiment. Here, the number of channels is not limited to what is shown on the drawing, and the number may also be larger or smaller than the case of the drawing.

Further, for example, a detailed setting of a high density adjustment is possible according to user's preference, and thereby it is possible to obtain a high-quality print without too much of “blur” and on which “black reproduction” is well adjusted.

Here, in the described second, third, fourth, fifth and sixth embodiments, a classification of the image data, a setting information and an operating state information are used as examples of the image related information. However, the image related information is not limited to the mentioned ones. For example, as the image related information, an additional information such as an information recorded in a magnetic layer of a film used by a film camera, the film having an APS (Advanced Photo System) correspondence, an Exif information of a digital camera having an Exif correspondence and the like may be used.

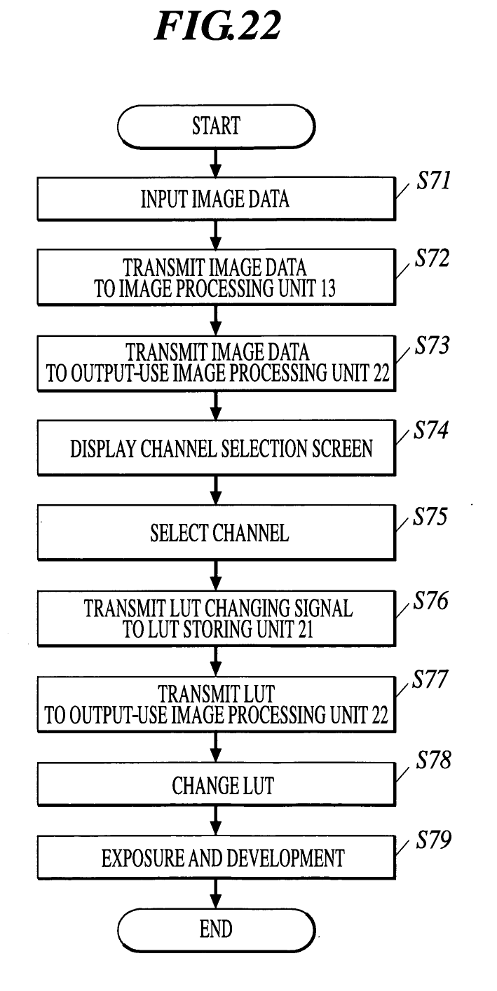

Next, an operation of the ninth embodiment will be described based on a flowchart illustrated in FIG. 22.

When an image data is inputted from one of the film scanner unit 4 and the like (S71), the image data is transmitted to the image processing unit 13 (S72). Then, after the processes that are the same as the first embodiment are performed, the image is displayed and also the image data is transmitted to the output-use image processing unit 22 (S73). Then, the operator operates the operating unit 3 to input an operating signal and to display a channel selection screen shown in FIG. 21 on the display unit 9 (S74), and further the operator operates the operating unit 3 to select a predetermined channel among the plurality of channels shown on the screen (S75).

Based on the selection result, the LUT changing signal is outputted to the LUT storing unit 21 (S76). Then, as well as the above-described first embodiment, an LUT is transmitted to the output-use image processing unit 22 (S77), the LUT corresponding to the LUT changing signal is changed to the LUT outputted from the LUT storing unit 21 (S78). Thereafter, an exposure and a development are performed (S79).

As above, according to the invention relating to the present embodiment, by changing a setting which already has been determined, it is possible to perform a printing according to user's preference, for example.

Further, since it is possible to preliminarily provide a plurality of expected setting conditions with respect to each channel, it is not necessary for the operator to perform a complicated operation, that is re-performing all the settings at each printing operation. Therefore, it is possible to change a plurality of settings by only selecting a channel.

Further, for example, a detailed setting of a high density adjustment is possible according to user's preference, and thereby it is possible to obtain a high-quality print without too much of “blur” and on which “black reproduction” is well adjusted.

The entire disclosure of a Japanese Patent Application No. 2004-150971, filed on May 20, 2004, and a Japanese Patent Application No. 2004-260283, filed on Sep. 7, 2004, including specifications, claims, drawings and summaries are incorporated herein by reference in their entirety.

1. An image recording method comprising:
obtaining an image data;
performing a predetermined process to the obtained image data;
creating a print based on an output data obtained from the outputted image data through an LUT; and
changing a density of a specific density area in an image of the print;
wherein the creating the print includes changing a part of the LUT substantially according to a density change instruction corresponding to the changing the density.

2. The method of claim 1, wherein in the changing the density, it is possible to input an operating state information for giving the density change instruction.

3. The method of claim 1, wherein in the changing the density, it is possible to change a detailed setting of the LUT.

4. The method of claim 1, further comprising displaying an information necessary for recording the image, wherein the displaying the information includes displaying the image based on the outputted image data.

5. The method of claim 1, wherein
the creating the print is performed by making a development device perform a development after a photosensitive material is exposed, and
the changing the density is performed based on an image related information being at least one of a setting information and an operating state information of the development device, and the setting information is selected from a classification of the image data, a type of the photosensitive material, a type of the development and a conveyance speed of the photosensitive material in the development device.

6. An image recording method comprising:
obtaining an image data;
performing a predetermined process to the obtained image data; and
creating a print based on an output data obtained from the outputted image data through an LUT;
wherein the creating the print includes judging whether it is necessary to change a density of a specific density area based on an image related information, and changing a part of the LUT substantially based on a result of the judging.

7. The method of claim 6, further comprising changing a detailed setting of the LUT.

8. The method of claim 6, wherein
the creating the print is performed by making a development device perform a development after a photosensitive material is exposed, and
the image related information is at least one of a classification of the image data, a setting information of the development device and an operating state information of the development device.

9. The method of claim 6, wherein the changing the part of the LUT comprises identifying a content of the image data for classifying the image data.

10. The method of claim 8, wherein the setting information of the development device is at least one of a type of the photosensitive material, a type of the development and a conveyance speed of the photosensitive material in the development device.

11. An image recording program making a computer execute:
obtaining an inputted image as an image data;
performing a predetermined process to the obtained image data;
creating a print based on an output data obtained from the outputted image data through an LUT;
wherein the creating the print includes changing a part of the LUT substantially according to an operation to change a density of a specific density area in the image.

12. The program of claim 11, wherein the changing the part of the LUT comprises obtaining an operating state information of a development device and in the changing the part of the LUT, it is possible to change the LUT according to the obtained operating state information.

13. The program of claim 13, wherein in the changing the part of the LUT, it is possible to change the LUT according to an operation to change a detailed setting of the LUT.

14. The program of claim 11, further making the computer execute displaying an information necessary for recording the image, wherein the displaying the information comprises displaying an image based on the outputted image data.

15. The program of claim 11, wherein
the creating the print is performed by making a development device perform a development after a photosensitive material is exposed, and
the changing the density is performed based on an image related information being at least one of a setting information and an operating state information of the development device, and the setting information is selected from a classification of the image data, a type of the photosensitive material, a type of the development and a conveyance speed of the photosensitive material in the development device.

16. An image recording program making a computer execute:
obtaining an inputted image as an image data;
performing a predetermined process to the obtained image data; and
creating a print based on an output data obtained from the processed image data through an LUT,
wherein the creating the print comprises judging whether it is necessary to change a density of a specific density area based on an image related information, and changing a part of the LUT substantially based on a result of the judging.

17. The program of claim 16, wherein the changing the part of the LUT comprises changing a detailed setting of the LUT according to an operation to change the density of the specific density area in the image.

18. The program of claim 16, wherein
the creating the print is performed by making a development device perform a development after a photosensitive material is exposed, and
the image related information is at least one of a classification of the image data, a setting information of the development device and an operating state information of the development device.

19. The program of claim 16, wherein the changing the part of the LUT comprises judging a content of the image data to classify the image data.

20. The program of claim 18, wherein the setting information of the development device is at least one of a type of the photosensitive material, a type of the development and a conveyance speed of the photosensitive material in the development device.
